(19) United States
(12) Patent Application Publication
(10) Pub. No.: US 2004/0236540 A1
(43) Pub. Date: Nov. 25, 2004

(54) CAD system utilizing network

(75) Inventors: Aki Tsuji, Sizuoka-ken (JP); Jian Liu, Sizuoka-ken (JP)

Correspondence Address: SMITH & HOPEN PA, 15950 BAY VISTA DRIVE, SUITE 220, CLEARWATER, FL, 33760

(73) Assignee: Technote Co., Ltd., Sizuoka-ken (JP)

(21) Appl. No.: 10/710,376

(22) Filed: Jul. 6, 2004

Related U.S. Application Data
(63) Continuation-in-part of application No. 09/606,868, filed on Jun. 29, 2000.
(60) Provisional application No. 60/142,313, filed on Jul. 2, 1999.

(30) Foreign Application Priority Data
Jun. 30, 1999 (JP) 11-185161
Jun. 16, 2000 (JP) 2000-181944

(51) Int. Cl. G06F 17/50

(52) U.S. Cl. 703/1

(57) ABSTRACT

A server computer comprises a real-number data storage section and a variable program (basic data for graphics) storage section and according to a request from client, reads real-number data and a variable program from the program data transmitting section in the server computer and sends it to a client computer; after being received by the program data receiving section in the client computer, the computing section substitutes the real-number data into the corresponding variables in the variable program, and while interpreting the variable program by the interpreting function for interpreting interpreter-type programming language of the computing section, executes the program to create graphic data; then the CAD graphic data creation section creates display data based on the graphic data created by the computing section, and displays the graphic on the graphic display unit and outputs the CAD data.

### CROSS REFERENCE TO RELATED DISCLOSURES

This disclosure is a continuation-in-part of a co-pending disclosure by the same inventors, filed Jun. 29, 2000, bearing Ser. No. 09/606,868, which claims priority to Japanese Application No. 2000-181944 filed Jun. 16, 2000 and Japanese Application No. Heisei 11-185161 filed Jun. 30, 1999.

### BACKGROUND OF THE INVENTION

1. Field of the Invention

This invention relates to a CAD system utilizing a network such as the Internet for sending CAD graphic data to a client computer from a server computer that is connected to the network, and relates to a CAD system that comprises a combination of a parametric method and part-data-management system on the Internet that distributes CAD graphic data for architectural or building parts over a network such as the Internet.

2. Description of the Prior Art

A conventional CAD system is such that graphic data for various parts is prepared in advance and distributed using media, or distributed over the Internet.

However, machine parts, electronic parts, building parts (sink, chair, table, toilet, plumbing, etc.) and the like have a large number of parts that have the same shape but are different sizes. An example of this kind of part is a typical hexagonal bolt that is an element part in machines. There are very many parts having the same shape but different size and length. Also, by supporting up to special lengths desired by the user, the number is unlimited. It is impossible to record and supply drawing data for each individual part, so currently only graphic data for a typical size having the same shape is prepared.

Also, in the case of registering a new part or changing the graphic data of an existing part, it is necessary to add or correct the graphic data for each individual part. In other words, when storing graphic data for many kinds of parts in each individual computer, a recording apparatus having an extremely large capacity is necessary, and increases in costs are unavoidable.

Therefore, it is necessary to supply CAD graphic data using a parametric method. The parametric method uses real-number data that gives the part shape dimensions and a drawing program for part shapes, and it substitutes that real-number data in the drawing program for part shapes, and executes the drawing program to create CAD graphic data for the part.

In this prior parametric method, the drawing program for part shapes is generally created using a development language in compiled form. Also, in the case of CAD graphic data for a part sold by various parts manufacturers, for the user of that part, that data is common data for everyone. This kind of CAD graphic data is created and supplied in various formats by various parts manufacturers such that it can be said to be unlimited.

Recently, by assembling this kind of graphic data using CAD, it has become possible to design a desired product in a very short period of time. By skillfully employing commercially sold parts and standard parts into products, it is possible to design inexpensive and high-performance products in a short period of time. This has caused CAD graphic data to occupy and increasingly important position.

However, using this prior parametric method to develop a drawing program for tens of thousands of part shapes in a compiled development language takes too much time and money, and it is not possible to satisfy the current demand. In considering the case of not being able to supply CAD part data over a network such as the Internet using this parametric method, one must personally record and store data that is common to everyone as a collection of CAD data in a memory apparatus in personal or company units. Also, when considering that engineers employed by manufacturers worldwide are doing such and thing, it can be said that this work is very much a waste of labor.

Also, when considering supplying graphic data over the Internet using this parametric method, for example in the case of GeomNet, there is prior technology for performing geometric calculations and drawing shapes over a network such as the Internet, however, the programs for performing that geometric calculation or drawing shapes was developed in the compiled type of development language of the prior parametric method, so when performing distribution over the Internet, it is integrated together with an Internet-distribution system, and when attempting to distribute a drawing program for tens of thousands of part shapes, the entire distribution system becomes very large, and too much time and money is required for development and maintenance, so it is not possible to satisfy the current demand.

In recent years, services of providing a variety of information or data via Internet are becoming more popular, and a CAD system utilizing Internet is considered.

For example, a system in which CAD graphic data is stored in advance on a server side connected to Internet, and upon a request from a user side, graphic data is provided from a server side to a user side via Internet is feasible.

In the case of such a CAD system, although there is an advantage that there is no need for storing CAD parts data on the user side, it is required to store in advance various types of parts data corresponding to various parts on the server side.

In addition, in the case where machine design is made, parts having identical shape and different dimensions are occasionally used, but it is almost impossible to store all data on parts having different dimensions individually on the server side from the viewpoint of data capacity.

In addition, if a type of CAD software, which the user uses is different from another, a data format of graphic data is generally different from another. Thus, it is required to reserve graphic data by each data format in advance on the server side, and a recording device having a tremendous amount of capacity is required.

Further, in the case where new parts are added or graphic data is updated on the server side, a number of graphic data must be changed simultaneously, and data management is cumbersome and costly.

Also, to create a drawing program for tens of thousands of different part shapes using the compiled development language of the prior parametric method, special knowledge of software development such as compiling technology and debugging methods is needed, so development takes a very long time and is nearly impossible.

Furthermore, when considering distributing the graphic drawing program that was created in compiled-type development language over the Internet, the graphic drawing program that was created in compiled-type development language must be integrated with the distribution system on the server side, so the Internet-distribution system becomes extremely large and thus the time and cost required for development and maintenance of the distribution system becomes to large, and it is not possible to satisfy the current demand.

### SUMMARY OF THE INVENTION

Taking these problems into consideration, the object of this invention is to provide a CAD system utilizing a network that is constructed such that a parametric method prepares real-number data that gives part shape dimensions and a variable program for drawing part shapes without having to prepare graphic data beforehand, and furthermore handles the variable program for drawing part shapes as data, and is separated from the distribution system and saved in a general-purpose database or the like and can quickly supply graphic data as needed by the user using a simple procedure.

In order to solve the aforementioned problems, according to the claim 1 of the present invention, there is provided a CAD system utilizing a network and comprises: a server computer that is connected to a network and at least one client computer that performs data transmission with said server computer via said network; and sends basic data for CAD graphic data from said server computer to said client computer according to a request from said client computer; wherein said server computer comprises: a storage means that stores basic data for said graphic data; and a program data transmitting section that reads said basic data for graphic data from said storage means according to a request from said client computer, and sends that data to said client computer; said client computer comprises: a program data receiving section that receives said basic data for graphic data; a computing section that creates graphic data based on said basic data for graphic data; and a CAD graphic data producing section that creates display data for the graphic display unit in said client computer based on the graphic data created by said computing section; said basic data for graphic data comprises a plurality of variable programs for drawing different graphics and real-number data that is substituted into the variables of said variable programs; said storage means of said server computer comprises a variable program storage section that stores said plurality of variable programs, and a real-number data storage section that stores a plurality of kinds of said real-number data; said program data transmitting section reads a specified variable program from said variable program storage section, and reads specified real-number data from said real-number data storage section according to a request from said client computer, then sends that data to said client computer; and said computing section of said client computer substitutes said specified real-number data into the variables of said specified variable program, then executes that program and creates graphic data.

According to the claim 2 of the present invention, there is provided a CAD system utilizing a network and comprises: a server computer that is connected to a network and at least one client computer that performs data transmission with said server computer via said network; and sends basic data for CAD graphic data from said server computer to said client computer according to a request from said client computer; wherein said server computer comprises: a storage means that stores basic data for said graphic data; and a program data transmitting section that reads said basic data for graphic data from said storage means according to a request from said client computer, and sends that data to said client computer; said client computer comprises: a program data receiving section that receives said basic data for graphic data; a computing section that creates graphic data based on said basic data for graphic data; and a CAD graphic data producing section that creates display data for the graphic display unit in said client computer based on the graphic data created by said computing section; said basic data for graphic data comprises a plurality of variable programs for drawing different graphics and real-number data that is substituted into the variables of said variable programs; said storage means of said server computer comprises a variable program storage section that stores said plurality of variable programs, and a real-number data storage section that stores a plurality of kinds of said real-number data; said program data transmitting section reads a specified variable program from said variable program storage section, and reads specified real-number data from said real-number data storage section according to a request from said client computer, then sends that data to said client computer; said variable program is created using an interpreter-type programming language; and said computing section of said client computer comprises an interpreting function for interpreting said interpreter-type programming language, and substitutes said specified real-number data into the variables of said specified variable program, then executes that variable program while interpreting it by the interpreting function for interpreting interpreter-type programming language, and creates graphic data.

According to the claim 3 of the present invention, there is provided the CAD system utilizing a network as claimed in claims 1 or 2 wherein said client computer comprises a graphic name list display control section for displaying a list of received graphic names of the basic data for graphic data provided from said server computer on the display unit; and a selected graphic name transmitting section that sends the names of graphics selected from said list of graphic names to said server computer; said program data transmitting section in said server computer reads said specified variable program and specified real-number data based on the graphic names that were sent from said selected graphic name transmitting section.

According to the claim 4 of the present invention, there is provided the CAD system utilizing a network as claimed in claims 1 or 2 wherein said server computer comprises a parts data list storage section that groups and stores part code numbers for each part and said real-number data corresponding to the code numbers; said program data transmitting section transmits the part data list containing the code numbers and the real-number data to said client computer according to a request of said client computer; said client computer comprises: a code number list display control section that creates a parts code number list from said sent parts data list transmitted, and displays the list on said graphics display unit; and said computing section substitutes real-number data for the parts that correspond to the names of the part code numbers selected from said displayed parts code number list into the variables of the variable program that corresponds to the names of said graphics and creates graphic data.

According to the claim 5 of the present invention, there is provided the CAD system utilizing a network as claimed in claims 4 wherein when part or all of the real-number data corresponding to the part code numbers selected from said part code number list in said client computer is input data that was input by the user, said computing section of said client computer substitutes said real-number data that was read from said parts data list storage section and said input data into the variables in said corresponding variable program and creates graphic data.

According to the claim 6 of the present invention, there is provided the CAD system utilizing a network as claimed in claims 1 or 2 wherein said client computer comprises a data format name selection function that is capable of selecting a data format name for the CAD software; and said CAD graphic data producing section converts the format of the graphic data created by said computing section, creates CAD graphic data having said selected data format, assigns a file name and stores the data in the memory unit.

According to the claim 7 of the present invention, there is provided the CAD system utilizing a network as claimed in claims 1 or 2 wherein said client computer comprises an interface name selection function that is capable of selecting a name for the data-exchange interface provided by the CAD software; and said CAD graphic data producing section converts the format of the graphic data created by said computing section to create CAD graphic data, and registers said CAD graphic data directly in said CAD software by way of said data-exchange interface.

According to the claim 8 of the present invention, there is provided the CAD system utilizing a network as claimed in claims 1 or 2 wherein comprising a parts database management program for managing parts data in said program data transmitting section of said server computer.

### BRIEF DESCRIPTION OF THE DRAWINGS

FIG. 1 is a block diagram depicting a schematic configuration of a CAD system utilizing a network according to the present invention;

FIG. 2 is a flowchart showing processing operations of the CAD system utilizing the network shown in FIG. 1;

FIG. 3 is a flowchart continued from FIG. 2;

FIG. 4 is a flowchart continued from FIG. 3;

FIG. 5 is a view showing a screen display example displayed on a graphic display unit of a client computer;

FIG. 6 is a block diagram showing a program data transmitting section of another embodiment;

FIG. 7 is a drawing showing an embodiment of the structure of the real-number data file for the example of a hexagonal bolt (+SW);

FIG. 8 is a drawing showing an embodiment of the structure of the real-number data file for the example of a front view of a hexagonal bolt (+SW);

FIG. 9 is a drawing showing an embodiment of the creation tool for creating the variable program that draws the part shape.

wherein reference numeral 1 denotes a server computer and reference numeral 2 denotes a client computer; reference numeral 3 denotes an internet; reference numerals 11 and 21 each denote a data input/output interface; reference numerals 12 and 12′ each denote a program data transmitting section; reference numeral 13 denotes a real data storage section; reference numeral 14 denotes a variable program storage section; reference numeral 15 denotes parts data list storage section; reference numeral 22 denotes a graphic name list display control section; reference numeral 23 denotes a selected graphic name transmitting section; reference numeral 24 denotes a parts code number list display control section; reference numeral 25 denotes a program data receiving section; reference numeral 26 denotes a computing section; reference numeral 27 denotes a CAD graphic data producing section; reference numeral 28 denotes a graphic display unit; and reference numerals W1 to W8 each denote a display region; reference numeral F101 denotes First line of the real-number data file; reference numeral F102 denotes Variable ?L; reference numeral F103 denotes Second line of real-number data file; reference numeral F104 denotes Part code number; reference numeral F105 denotes TAB key; reference numeral F106 Real-number data; reference numeral F107 denotes Real-number data when M10 is selected; reference numeral F201 denotes Line number; reference numeral F202 denotes Command number; reference numeral F203 denotes Separator ‘.’; reference numeral F204 denotes Arithmetic operator; reference numeral F205 denotes Arithmetic function; reference numeral F206 denotes Variable program; reference numeral F301 denotes Area the displays the graphic drawn by the variable program; reference numeral F302 denotes Area for displaying and editing the variable program; reference numeral F303 denotes Area for displaying the variables into which real-number data has been substituted; reference numeral F304 denotes Command line for drawing a straight line.

### DESCRIPTION OF THE PREFERRED EMBODIMENTS

Hereinafter, a CAD system utilizing a network according to the present invention (hereinafter, referred to as a “CAD system”) will be specifically described with reference to the accompanying drawings. The CAD system described hereinafter is characterized in that the server side merely transmits real data and a variable program which is a basis of graphics, and all of the graphic data producing operation and CAD format converting operation are performed by an automatically installed program on the client side.

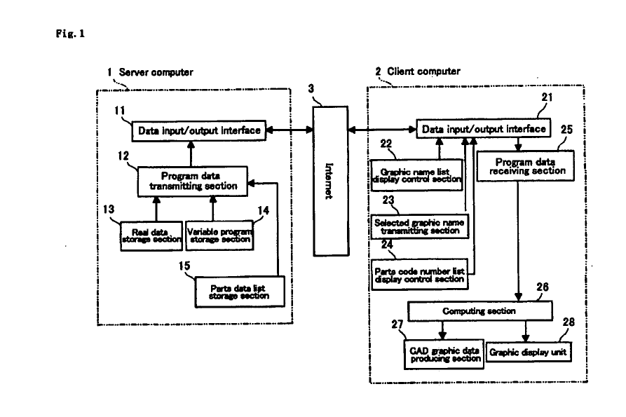

FIG. 1 is a block diagram depicting a schematic configuration of a CAD system according to the present invention. As shown in the figure, the server computer 1 and the client computer 2 are connected to each other via the Internet 3.

The server computer 1 comprises a data input/output interface 11, program data transmitting section 12, real data storage section 13, variable program storage section 14 and parts data list storage section 15. Here, the real data storage section 13 and variable program storage section 14 are storage means.

The data input/output interface 11 performs data input/output relay.

The program data transmitting section 12 reads a predetermined variable program from the variable program storage section 14 according to a request from the client computer 2; reads predetermined real data from the real data storage section 13; and transmits these read variable program and real data to the client computer.

The real-data storage section 13 stores a plurality of kinds of real-number data to be substituted into the variables of the variable program. The variable program storage section 14 stores a plurality of variable programs for drawing different graphics, respectively.

The parts data list storage section 15, in the place of the real data storage section 13, stores a parts list (includes real-number data) that comprises part code numbers grouped with real-number data.

The client computer 2 comprises a data input/output interface 21, a graphic name list display control section 22, a selected graphic name transmitting section 23, a parts code number list display control section 24, a program data receiving section 25, a computing section 26, a CAD graphic data producing section 27, and a graphic display unit 28.

The data input/output interface 21 performs data input/output relay. The graphic name list display control section 22 displays on the graphic display unit 28 a list of graphic names capable of receiving provision of graphic data from the server computer 1.

The selected graphic name transmitting section 23 transmits to the server computer 1 a name of a graphic selected from a list of graphic names. The parts code number list display control section 24 displays on the graphic display unit 28 a parts code number list capable of receiving provision of base data of graphic data from the server computer 1.

The program data receiving section 25 receives the variable program and real-number data from the server computer 1. The computing section 26 substitutes specified real-number data into the respective variables in a specified variable program, and then executes the program and creates graphic data while interpreting that program by the interpreter-type programming language of the computing section 26.

The CAD graphic data producing section 27 produces display data capable of being displayed by the graphic display unit 28 based on the graphic data produced by the computing section 26. The graphic display unit 28 performs graphic display based on the display data produced by the CAD graphic data producing section 27.

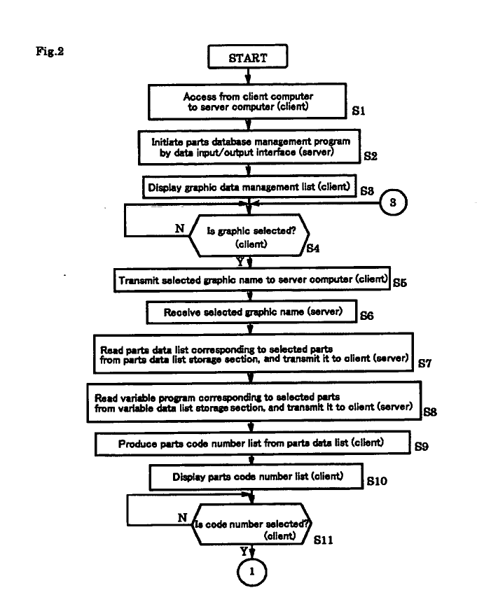

FIG. 2 to FIG. 4 are flowcharts showing processing operations of the CAD system shown in FIG. 1. Hereinafter, an operation of the CAD system of the present embodiment will be described on the basis of the flowcharts.

First, as shown in FIG. 2 (step S1), the client computer 2 provides access to the server computer 1 via the internet 3. The data input/output interface 11 calls and initiates a parts database management program (step S2).

A graphic data management list is displayed on the display screen of the client computer 2 as shown in (step S3). This list shows a list of parts that can be selected on the client side, and the user can select an arbitrary part from the list by mouse operation or the like.

Next, as shown in (step S4), it is judged whether or not the user select a graphic name from the graphic data management list by mouse operation or the like. In the case where the user selects the name of the graphic, the processing goes to (step S5) in which the selected graphic name is transmitted to the server computer 1. The server computer 1 receives the selected graphic name (step S6).

The parts database management program initiated in (step S2) reads from the parts data list storage section 15 a parts data list corresponding to the user selected graphic name, and then, transmits the list to the client computer 2 via the data input/output interface 11 (step S7).

In addition, the server computer 1, as shown in (step S8), reads from the variable program storage section 14 a variable program corresponding to the selected graphic name, and transmits the program to the client computer 2 via the data input/output interface 11 (step S8).

When the client computer 2 receives the parts data list, it produces a parts code number list from the parts data list (step S9), and displays the produced parts code number list using browse or the like (step S10).

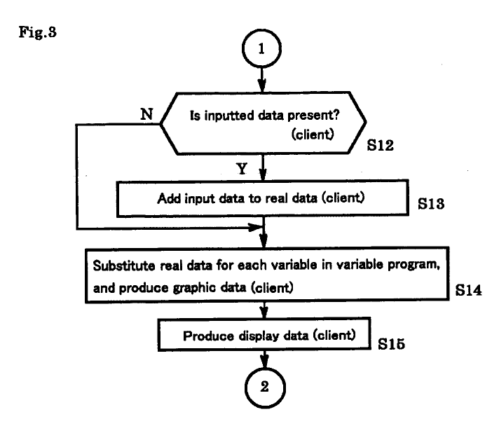

Next, the client computer 2 judges whether or not the user select any code number from among the parts code number list using the mouse or the like (step S11). When the user selects a code number, the computer judges whether or not the user inputs variable data corresponding to the selected code number (step S12 in FIG. 3).

When the user inputs input data, the input data is added to the real-number data (step S13). Next, the real-number data is substituted for the variables in the variable program, and the variable program is executed to create graphic data while interpreting the variable program by the interpreter-type programming language of the computing section 26 (step S14). Furthermore, display data is created from the created graphic data (step S15).

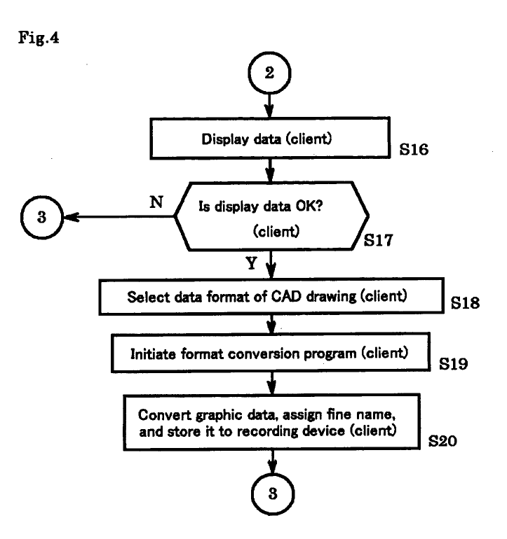

The display data is created in a data format that can be processed by a general-purpose OS (Operating System) such as Windows or UNIX, for example, GIF file, DWF file, JPG file. Then, the client computer 2, as shown in FIG. 4 (step S16), perform displaying based on the produced display data. Alternatively, graphic data may be directly drawn on the graphic display unit with a program using C language, basic language or the like without producing the display data.

Next, as shown in step S17, the client computer 2 seeks confirmation from the user whether or not the graphic that is displayed by the graphic display unit 28 is as intended. When the graphic is not as intended, the client computer 2 returns to step S4 shown in FIG. 2 in order to reselect the part, and when the graphic is as intended, then as shown in step S18, the client computer 2 has the user select the data format name for the CAD drawing and the interface name for exchanging CAD software data.

The reason for having this process is because the data format and data-exchange interface of the CAD software are not matched, so in step S18, the user selects a data format name and a CAD software data-exchange interface name that corresponds to the CAD software used by the user, such as a DXF file, DWG file, IGES file, BMI file or the like.

Next, the client computer 2 reads the format-conversion program that corresponds to the data format or CAD software data-exchange interface selected by the user, and initiates the read program (step S19).

As shown in step S20, the format-conversion program converts the graphic data created in step S14 to the data format that was selected by the user, then adds a new file name and stores it in the memory apparatus. After that, the created CAD graphic data is displayed on the CAD screen according to an instruction from the user. Also, connecting with the CAD software data-exchange interface, and registers the CAD graphic data directly in the CAD software.

The foregoing processing operations shown in the flowcharts of FIG. 2 to FIG. 4 are summarized as follows. In (steps S1 to S8), when the user selects parts, the server computer 1 transmits to the client computer 2 variable program and real data (parts data list) which is base data of the graphic data corresponding to the parts.

Next, in steps S9 to S17, it substitutes real-number data that corresponds to the code number selected by the user into the variables of the variable program file that corresponds to the part selected by the user, and while interpreting the variable program by the interpreter-type programming language of the computing section 26, performs computation and creates graphic data based on the computation results, after which it creates display data to be displayed on the client computer 2 and displays that data.

Next, in steps S18 to S20, after converting the graphic data to the data format specified by the client computer 2, and attaches a new file name and stores the file. Also, using the CAD software data-exchange interface, it directly registers the CAD graphic data in the CAD software.

Thus, in the illustrative embodiment, the server side merely transmits real data which is a basis of graphics; and a variable program, whereby all operations such as graphic data production and CAD format conversion are performed by an automatically installed program on the client side. Thus, there is no need for reserving graphic data in the server computer 1 or client computer 2.

Also, the variable program storage section 14 that stores the variable program is separated from the program data transmitting section 12, and the program data transmitting section 12 reads the variable program form the variable program storage section 14 and sends it as data, so even when the program for the program data transmitting section 12 and the variable program stored in the variable program storage section 14 are changed, they do not affect each other, and thus development time is shortened and server maintenance is also reduced.

Also, since the variable program is created using an interpreter-type programming language, it can be put in the form of a database with the real-number data and can also be searched.

The user merely selects desired parts from the parts list displayed on the screen, thereby making it possible to acquire graphic data corresponding to the parts. In addition, the user can input variable data such as parts dimensional value in advance, making it possible to obtain graphic data on special parts in accordance with a simplified procedure. Further, the client computer 2 substitutes variable data for each variable in the variable program, thereby producing graphic data. Thus, graphic data having different dimensions can be easily produced, and graphic data with its high precision and high reliability can be provided.

Further, the user can utilize base data of the graphic data downloaded on the client computer 2, and thus, can construct a unique database with its very low cost. Constructing such database enables reuse or modification of the base data of the downloaded graphic data, and usable and economical database is obtained.

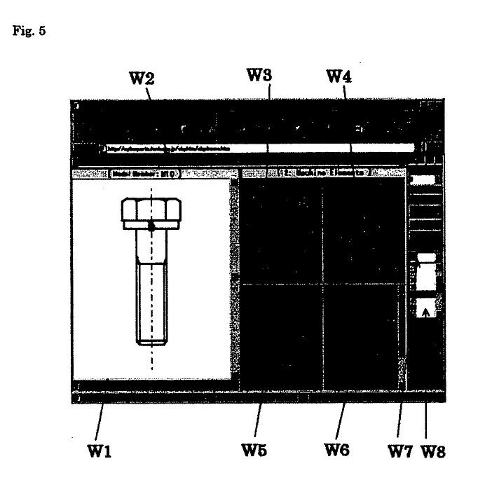

FIG. 5 is a view showing an screen display example displayed on the graphic display unit 28 of the client computer 2. The screen of FIG. 5 shows an example when a part having a hierarchical structure is selected and displayed. In a display region W1 of the screen inside, display data produced by the processing in (step S15) is displayed.

Here, in the display region W1, there is shown a display example of a hexagonal bolt. A final name of parts of this hexagonal bolt is a hexagonal bolt+SW (which means Spring Washer), for example. A variable program for displaying a graphic corresponding that name is of one type (because the shape is identical). However, for variable data, there are 32 types of data whose sizes are difference from M3 to M80. These types of data are arranged so as to be selected from among the code number list produced from the parts data list (including real data).

A major-classification page field is displayed in the display area W2, a first parts table for selecting a first level of parts is displayed in the display area W3, a second parts table for selecting a second level of parts with the parts selected from the first parts table as the object is displayed in the display area W4, a third parts table for selecting a third level of parts with the parts selected from the second parts table as the object is displayed in the display area W5. The selection of parts from the first through third parts tables corresponds to the processing shown in FIG. 2 (step S4). After the parts data list that corresponds to the graphic name selected from the third parts list is sent from the server computer, the code number list is created and displayed in the display area W6. This corresponds to the processing of step S7 to step S10.

In addition, an input box for dimensions corresponding to selected parts is displayed in a display region W7 in the screen of FIG. 5, and a specification data selection list is displayed in the lower display region W8.

As shown in FIG. 5, the user select parts in accordance with a menu displayed on the screen of the client computer 2, thereby making it possible to obtain graphic data corresponding to desired parts simply and speedily.

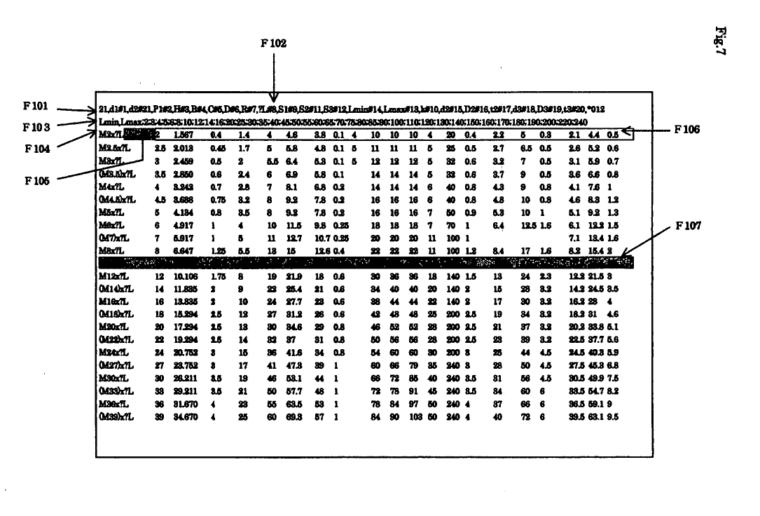

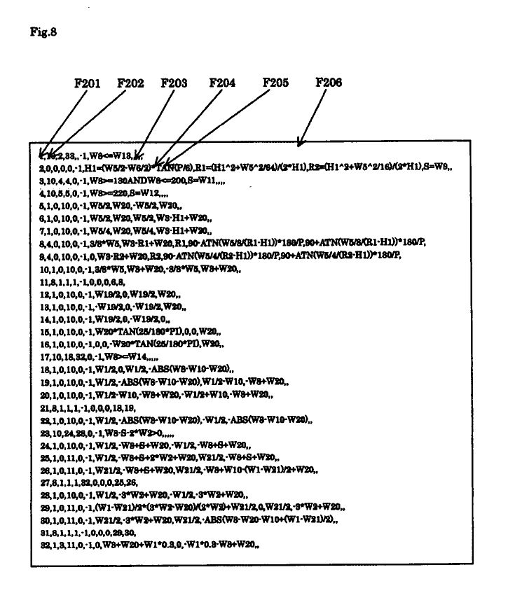

FIG. 7 and FIG. 8 are examples of when machine element—JIS standard part—screw part—bolt (with washer)—hexagonal bolt (+SW) are selected, and shows the structure of the real-number data and variable program files.

First, the method of assigning file names to the real-number data and variable program files will be explained. The method of assigning names to the real-number data and variable program files is automatically set mainly according to standards given below.

The 26 classifications A to Z are listed in the major-classification-page field displayed in the display area W2 shown in FIG. 5, 01 to 99 are assigned to the first part table displayed in display area W3 shown in FIG. 5, 01 to 99 are assigned to the second part table displayed in display area W4 shown in FIG. 5, and 01 to 99 are assigned to the third part table displayed in display area W5 shown in FIG. 5.

In the case of the hexagonal bolt (+SW), it is on the second page (machine elements), so B is assigned; the first part table is at the very top (screw parts), so 01 is assigned; the second part table is the third from the top (bolts (with washers)), so 03 is assigned; and the third part table is the second from the top (hexagonal bolts (+SW)), so 02 is assigned; and combining all of these together, the file name becomes B010302. The extension of the real-number data file is DT, so the real-number data file name becomes B010302.DT.

The variable program files are divided by the extensions PR0 (front view), PR1 (side view), PR2 (top view) and PR3 (cross-sectional according to the projected surfaces of the drawing, and the respective file names become B010302.PR0, B010302.PR1, B010302.PR2 and B010302.PR3. Normally, for one part, there is one real-number data file and a maximum of four program variable files. The code number of the part listed in the real-number data file B010302.DT is displayed in the fourth part table that is displayed in the display area W6 shown in FIG. 5. The reason that the variable program files are divided and recorded according to the respective projected surfaces is that when calling up a part from CAD that is recorded in the part library, and pasting it and using it directly on a CAD drawing that is being created, other projected surfaces become obstructive.

The real-number data file is a TEXT file, and its structure will be explained using the example of the real-number data file B010302.DT for a hexagonal bolt (+SW).

When the real-number data file B010302.DT for a hexagonal bolt (+SW) is opened using a memo pad (notepad.exe), it is displayed as shown in FIG. 7, and the first number 21 on the first line (F101 in FIG. 7) shows the number of variables. Next, the variable name and the variable identification are written between the commas. The variable identification is the unique number that the variable has, and when a new variable name (d1, etc.) is added, it is automatically set, and once set, it will never change. (Hereafter, the variable identification will simply be referred to as the variable ID). The first variable name is d1 and the variable ID is the number that follows #, and will be the same below.

The number 012 following the asterisk * indicates the projected surfaces of the drawing. 0 indicates the front view, 1 indicates the side view, 2 indicates the top view and 3 indicates the cross-sectional view. Since *012 is entered, it indicates that there is a front view, side view and top view variable program file for the data B010302.DT.

Variables with a question mark ? attached to the start of the variable are user-input variables for which the user performs input. For ?L (F102 in FIG. 7), the user inputs the bolt length of the corresponding bolt in the input BOX displayed in display area W7 in FIG. 5.

Standard lengths are prepared in advance for the user-input variable, and in order to have the user select a value from among these, the standard lengths are listed in the second line (F103 in FIG. 7). The first characters Lmin, Lmax in the second line (F103 in FIG. 7) specify the range of standard lengths using variables. For example, in the case of M10, Lmin=14 and Lmax=100, so the range of standard lengths is 14 to 100, and is displayed in display area W8 in FIG. 5. When the standard lengths are not necessary, only the dimension-input BOX is displayed in the display area W7 in FIG. 5. The real-number data starts from the third line. The code number (M6x?L) (F104 in FIG. 7) of the part is given in the first column.

When the standard length is selected for ?L in the code number (M6x?L) (F104 in FIG. 7), a numerical value for the variable ?L (F102 in FIG. 7) is entered, and the actual code number is created. Data is listed from the second column (F106 in FIG. 7) in the order of the variable listed in the first line. Data are separated by a TAB (F105 in FIG. 5).

A plurality of variables, called variables Wi, are used in the variable program files. (The i of Wi is an additional number, and it becomes the variable ID in the real-number data file.) As the variable ID in the real-number data file, this plurality of variables Wi is linked to the variable name (d1, etc.) entered in the real-number data file. The reason for doing this is that after the variable ID in the real-number data file has been set, it never changes, so even though the variable name (d1, etc.) in the real-number data file changes, it does not affect the variable program files. Actually, when M10 (W6 in FIG. 5) is selected, the relationship between the variables Wi used by the variable program files and the variable name (d1, etc.) or data in the real-number data file is as described below.

W1=d1#1=10 W21=d2#21=8.376 W2=P1#2=1.5 W3=H#3=7 W4=B#4=17 W5=C#5=19.6 W6=D#6=16.5 W7=R#7=0.4 W8=?L#8=user selection or input

W9=S1#9=26 W11=S2#11=26 W12=S3#12=26 W14=Lmin#14=14 W13=Lmax#13=100 W10=k#10=1.2 W15=d2#15=10.5 W16=D2#16=21 W17=t2#17=2 W18=d3#18=10.2 W19=D3#19=18.4 W20=t3#20=2.5

The variable program files are also TEXT files, and the structure will be explained using the variable file B010302.PR0 for the front view of the hexagonal bolt (+SW) as an example.

When opened using the memo pad (notepad.exe), the variable program file B010302.PR0 for the front view of the hexagonal bolt (+SW) is as displayed in FIG. 8, and while interpreting the listed variable program (F206 in FIG. 8) in the following order, the program is executed and drawing data are created.

A) Data are read from the real-number data file and the variable program (F206 in FIG. 8) is read from the variable program file into memory, and the real-number data (F107 in FIG. 7) in the real-number data file are substituted as shown below into the variables Wi used by the variable program. The values held by the variables Wi are double-precision real number data. The values in the parentheses ( ) are the variable names given in the real-number data that correspond to the variables Wi and are given for convenience.

W1=10(d1) W2=1.5(P1) W3=7 (H)

W4=17 (B) W5=19.6 (C) W6=16.5 (D)

W7=0.4 (R) W8=user selection or input (in the case of W8 in FIG. 5, 40 is selected) (?L) W9=26 (S1) W10=1.2 (k) W11=26 (S2) W12=26 (S3) W13=100 (Lmax) W14=14 (Lmin) W15=10.5 (d2) W16=21 (D2) W17=2 (t2) W18=10.2 (d3) W19=18.4 (D3) W20=2.5 (t3) W21=8.376 (d2)

B) Character strings are interpreted starting from line 1 in FIG. 8 by the interpreting function of the computing section for interpreting interpreter-type programming language. The variable program files are TEXT files and are created using an interpreter-type programming language, and since they exist as data, computing is not performed for the variable program file itself. They are executed by interpreting the character string starting from line 1 by the interpreting function of the computing section for interpreting interpreter-type programming language.

The variable program files are separated by commas ‘,’ (F203 in FIG. 8) and the numerical character string up to the first comma ‘,’ is the line number (F201 in FIG. 8). The number character string up to the next comma ‘,’ is the command number of the next line (F202 in FIG. 8).

The command numbers indicate the commands of the variable program, and are defined as shown below.

0=local variable definition 1=line 2=point 3=circle 4=arc 5=text 6=C square 7=R square 8=copy 9=placement 10=conditions

The character strings from that line on are analyzed according to these command numbers. When there are arithmetic operator characters such as \hat{ }, *, /, +. −. =(F204 in FIG. 8), or the arithmetic function character strings such as SIN( ), COS( ), TAN( ), ABS( ) or SQR( ) (F205 in FIG. 8), the program is executed while performing interpretation according to arithmetic equations or functions, and the graphic coordinates are given using double-precision real numbers.

C) A vector diagram is displayed in the drawing display field according to the obtained graphic coordinate data.

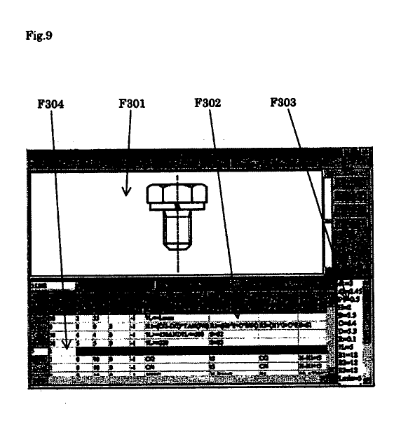

FIG. 9 is a drawing showing an example of the variable-program-creation tool developed for creating a variable program for drawing graphics of this invention.

Real-number data is called up from the real-number file (B010302.DT) and that data is substituted into the variables, and displayed in the variable display area F303 in FIG. 9. The variable program is called up from the variable-program file (B010302.PR0) shown in FIG. 8 and displayed in the area for displaying and editing the variable program at the bottom of FIG. 9 (F302 in FIG. 9) in table format, and the variable program is edited while watching the graphic displayed in the area for displaying the graphic at the top of FIG. 9 (F301 in FIG. 9). The system interprets the variable program that is displayed and edited in the area for displaying and editing the variable program (F302 in FIG. 9), and executes computation to create coordinate data for the graphic elements from the computed results, and then displays a vector drawing in the area for displaying the graphic at the top of FIG. 9 (F301 in FIG. 9).

For example, in the case where the line number in FIG. 9 is the fifth line, the command for writing a straight line corresponding to the element highlighted in the drawing is displayed in table format (F304 in FIG. 9), and each graphic element of the drawing that is displayed at the top corresponds 1-to-1 with each respective line in the table at the bottom.

The command contents for each command used by the interpreter-type programming language will be explained below.

In FIG. 9, the first column of the area (F302 in FIG. 9) at the bottom that displays and edits the variable program is the line number (also called the command address), and the second column shows the command number. The contents of the third column on differ according to the command number, and are as described below.

(1) Local variable definition command (command number=0)

The local variable definition command defines a local variable, and it is possible to substitute a complex variable equation into that local variable beforehand, and then after the substitution, that local variable can be used instead of the complex variable equation substituted, so the coordinate specifications of the element are greatly simplified.

Column 3=Unused

Column 4=Unused

Column 5=Unused

Column 6=Jump destination after this command is executed

Column 7=Local variable definition 1

Column 8=Local variable definition 2

Column 9=Local variable definition 3

Column 10=Local variable definition 4

Column 11=Local variable definition 5

A shown above, it is possible to define five local variables on one line. In the case where that is not enough, it is possible to use a local variable definition command on the next line, to define new local variables.

The defined local variable is effective in the variable program for which that local variable is defined, and the local variable that is defined in the local variable definition 1 field can be used from the local variable definition 2 field. The variables are always reflected on the downward side, but not reflected on the upward side. In the case where the coordinate calculation is a complex variable equation, coordinates for each element can be easily specified by defining the local variable beforehand and substituting the complex variable equation into that local variable.

(2) Line Command (Command number=1)

The line command draws a line from the starting coordinate position to the ending coordinate position using the specified line color and line type.

Column 3=Line type No.

Column 4=Color No.

Column 5=Unused

Column 6=Jump destination after this command is executed

Column 7=Starting coordinate X1

Column 8=Starting coordinate Y1

Column 9=Ending coordinate X2

Column 10=Ending coordinate Y2

Column 11=Unused

Starting coordinates (X1, Y1) and ending coordinates (X2, Y2) can be specified using an equation or numerical values.

(3) Point command (Command number=2)

The point command draws a point at the coordinates (X, Y) using the specified color.

Column 3=Unused

Column 4=Color No.

Column 5=Unused

Column 6=Jump destination after this command is executed

Column 7=Point coordinate X

Column 8=Point coordinate Y

Column 9=Unused

Column 10=Unused

Column 11=Unused

The point coordinates (X, Y) can be specified using variable equations or numerical values.

(4) Circle command (Command number=3)

The circle command draws a circle having a specified radius R at the center coordinates (X, Y) using the specified color and line type.

Column 3=Line type No.

Column 4=Color No.

Column 5=Unused

Column 6=Jump destination after this command is executed

Column 7=Center coordinate X

Column 8=Center coordinate Y

Column 9=Radius R

Column 10=Unused

Column 11=Unused

The center coordinates (X, Y) and the radius R can be specified using variable equations or numerical values.

(5) Arc command (Command number=4)

The arc command draws an arc having a specified radius R at center coordinates (X, Y) from a starting angle to an ending angle using the specified color and line type. The unit used for specifying the starting angle and ending angle is degrees.

Column 3=Line type No.

Column 4=Color No.

Column 5=Unused

Column 6=Jump destination after this command is executed

Column 7=Center coordinate X

Column 8=Center coordinate Y

Column 9=Radius R

Column 10=Starting angle

Column 11=Ending angle

The center coordinates (X, Y), radius R, starting angle and ending angle can be specified using variable equations or numerical values.

(6) Text command (Command number=5)

The text command draws text using a specified text color, text angle, text height with the specified coordinates (X, Y) being on the left side. The text angle is specified in degrees and the text height and text width are specified in mm. The specification position in each field is as follows.

Column 3=Unused

Column 4=Text color No.

Column 5=Unused

Column 6=Jump destination after this command is executed

Column 7=Text coordinate X

Column 8=Text coordinate Y

Column 9=Text height

Column 10=Text angle

Column 11=Text data

The center coordinates (X, Y), text height and text angle can be specified using variable equations or numerical values.

(7) C square command (Command number=6)

The C square command draws a rectangular shape having an angled chamfered edge.

Column 3=Line type No.

Column 4=Color No.

Column 5=Chamfer position

Column 6=Jump destination after this command is executed

Column 7=Opposing angle coordinate X1

Column 8=Opposing angle coordinate Y1

Column 9=Opposing angle coordinate X2

Column 10=Opposing angle coordinate Y2

Column 11=Chamfer dimension

The angle coordinates (X1, Y1), opposing angle coordinates (X2, Y2) and chamfer dimension can be specified using variable equations or numerical values.

(8) R square command (Command number=7)

The R square command draws a rectangular shape having a round chamfered edge.

Column 3=Line type No.

Column 4=Color No.

Column 5=Chamfer position

Column 6=Jump destination after this command is executed

Column 7=Opposing angle coordinate X1

Column 8=Opposing angle coordinate Y1

Column 9=Opposing angle coordinate X2

Column 10=Opposing angle coordinate Y2

Column 11=Chamfer radius dimension

The opposing angle coordinates (X1, Y1), opposing angle coordinates (X2, Y2) and chamfer radius dimension can be specified using variable equations or numerical values.

(9) Copy command (command number=8)

The copy command copies the elements from the starting command address in column 10 to the ending command address in column 11 according to the copy type in column 3, the distance in the X direction in column 7, the distance in the Y direction column 8 and the rotation angle in column 9.

(10) Placement command (Command number=9)

The placement command is currently not registered.

(11) Condition command (Command number=10)

The conditions command is used for changing the flow of the program or calculating variables according to set conditions. The condition field in column 7 is used when using relation operators (>, <, =, <=. >=), or logical operators (AND, OR) to compare two variable equations or numerical values, or to check a plurality of conditions, with the comparison result being ‘True’ or ‘False’.

For example:

A>B: When A is greater than B, the result is ‘True’, otherwise the result is ‘False’.

A=B: When A is equal to B, the result is ‘True’, otherwise the result is ‘False’.

A<B AND B<C: When A is less than B or when B is less than C, the result is ‘True’, otherwise the result is ‘False’.

Column 3 and column 4 are used for changing the flow of the program according to the comparison result.

When a command address is specified in column 3 and the result is ‘True’, the program jumps to that command address.

When a command address is specified in column 4 and the result is ‘False’, the program jumps to that command address.

Column 8 to column 11 are used when calculating the input variable equation according to the comparison result.

Columns 8 and 9 perform calculation when the comparison result is ‘True’.

Columns 10 and 11 perform calculation when the comparison result is ‘False’.

The contents of each of the commands of the interpreter-type programming language were explained above. By executing the program while interpreting these commands, it is possible to create CAD graphic data for various sizes of the same shape by simply substituting in real-number data for different graphic sizes having the same shape. For example, in the previous example of the hexagonal bolt (+SW), CAD graphic data for all bolts M3 to M80 was created by the variable program in FIG. 8. Moreover, when there is a mistake in the shape, by simply correcting the variable program, it is reflected on all of the graphic data created by this variable program, thus simplifying the work of correcting data. Of course, by adding a new command, it is possible to create more complex graphics.

Functions that are recognized by the interpreter-type programming language are as follows (there is no distinction between upper-case and lower-case letters).

1. SIN( ): Sine (sine value)

The sine value of the equation given between the parentheses is returned. The unit used for the equation is radians.

2. COSO: Cosine (cosine value)

The cosine value of the equation given between the parentheses is returned. The unit used for the equation is radians.

3. TAN( ): Tangent (tangent value)

The tangent value of the equation given between the parentheses is returned. The unit used for the equation is radians.

4. ATN( ): Arctangent (arctangent value)

The arctangent value of the equation given between the parentheses is returned in radians.

The obtained value is from −π/2 to π/2.

5. ABS( ): Absolute value

The absolute value of the equation in the parentheses is returned.

6. SQR( ): Square root

The square root of the value specified by the equation between the parentheses is returned.

It is also possible to add new functions.

The arithmetic operators used by interpreter-type programming language are given below.

\hat{ }: Exponential operator

Example: X\hat{ }Y Order of execution of operation: 1

*: Multiplication operator

Example: X*Y Order of execution of operation: 2

/: Division operator

Example: X/Y Order of execution of operation: 2

+: Addition operator

Example: X+Y Order of execution of operation: 3

−: Subtraction operator

Example: X-Y Order of execution of operation: 3

=: Assignment operator

Example: X=Y Order of execution of operation: 4

Parentheses ( ) are used to change the order of execution of operation. Operators between parentheses are executed before other operators. The normal order of execution is performed between parentheses.

The variable name on the left side of the assignment operator is assigned after all of the operations on the right side have been executed.

In the aforementioned illustrative embodiment, although an example of producing two-dimensional graphic data has been described, a variable program file or real data is changed, thereby making it possible to produce three-dimensional graphic data.

In addition, in the aforementioned illustrative embodiment, although an example of producing graphic data on mechanical parts has been described, the present invention is applicable similarly in the case where graphic data on electrical parts such as transistor or diode; or graphic data for architectural members is produced.

Further, in the aforementioned illustrative embodiment, although an example when the server computer 1 and the client computer 2 are connected with each other via the Internet 3, the present invention is applicable in the case where the server computer 1 and the client computer 2 are connected to various networks other than the Internet 3.

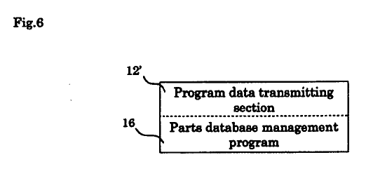

In addition, as shown in FIG. 6, the CAD system can comprise a parts database management program for parts data in a program data transmitting section 12′ in the server computer. In such case, parts data can be searched according to a request from the client computer.

### 2. INDUSTRIAL APPLICABILITY

As explained in detailed above, the overall a CAD system utilizing network of this invention is constructed by combining a parametric method (a parametric method accomplished by a variable program that is created in an interpreter-type programming language) and a parts data management system on the Internet.

More specifically, the basic data for CAD graphic data comprising real-number data and variable programs is separated from the transmitting section of the server computer and stored in the real data storage section and variable program storage section of the server computer, and after the real-number data and variable programs are sent from the server computer and received by the client computer according to a request from the client computer, the client computer substitutes real-number data into the corresponding variables in the variable program, then executes the variable program while interpreting it by the interpreting function for interpreting interpreter-type programming language of computing section and creates the graphic data and displays that graphic on the display unit, and also outputs the CAD data. With this kind of construction, the invention has the following effects.

According to the present invention, the server computer merely transmits real-number data and a variable program which is a base of graphics; whereby all operations such as graphic data production or CAD format conversion are performed by an automatically installed program on the client side. Thus, there is no need for reserving graphic data in the server computer or client computer in advance.

Also, the variable program of this invention is created in an interpreter-type programming language and does not rely on compiling techniques or other development languages, so it is possible to handle the variable program like data. The variable program exists in the overall CAD system like data, so it is possible to easily put it into a database. Moreover, when creating the variable program, by simply having knowledge of geometry and machine or architectural drawings, it is possible for anyone to easily create the program without having a special understanding of special software development such as compilation technology or debugging methods. It is also possible to concentrate on the contents to create. By doing so, it is possible to reduce costs when creating the variable program.

Furthermore, since the variable program is created using a interpreter-type programming language, it is possible to register the variable program in a general-purpose database in realtime by way of a network such as the Internet without having to recompile it, and the registered variable program can be reflected instantaneously on the side of the user by way of the network such as the Internet. Moreover, with the method of separating this kind of variable program from the program data transmitting section on the side of the server computer of this invention, and stored as data, even without using a plug-and-play method or wrapper technique, there is no need to recompile the program of the program data transmitting section or to stop the server every time a variable program is added or updated, so it is possible to simplify development and maintenance of the program for the program data transmitting section and lower costs. Also, it is possible to save a large quantity of variable programs.

In addition, only the data which is a base of multiple types of graphic data is transmitted, and thus, the data download time can be reduced significantly. Arbitrary graphic data which each of the users wants can be provided to a number of users via a network, and thus, a CAD system with its high usability and excellent performance can be provided.

In addition, when the user inputs variable data such as dimensional value, graphic data is produced in consideration of the input data. Thus, graphic data with high precision and high reliability can be provided in accordance with the simplified procedure. Further, real-number data or a variable program is updated, whereby graphic data on new parts can be provided to a number of users speedily.

1. A CAD system utilizing a network and comprises: a server computer that is connected to a network and at least one client computer that performs data transmission with said server computer via said network; and sends basic data for CAD graphic data from said server computer to said client computer according to a request from said client computer; wherein said server computer comprises: a storage means that stores basic data for said graphic data; and a program data transmitting section that reads said basic data for graphic data from said storage means according to a request from said client computer, and sends that data to said client computer; said client computer comprises: a program data receiving section that receives said basic data for graphic data; a computing section that creates graphic data based on said basic data for graphic data; and a CAD graphic data producing section that creates display data for the graphic display unit in said client computer based on the graphic data created by said computing section; said basic data for graphic data comprises a plurality of variable programs for drawing different graphics and real-number data that is substituted into the variables of said variable programs; said storage means of said server computer comprises a variable program storage section that stores said plurality of variable programs, and a real-number data storage section that stores a plurality of kinds of said real-number data; said program data transmitting section reads a specified variable program from said variable program storage section, and reads specified real-number data from said real-number data storage section according to a request from said client computer, then sends that data to said client computer; and said computing section of said client computer substitutes said specified real-number data into the variables of said specified variable program, then executes that program and creates graphic data.

2. A CAD system utilizing a network and comprises: a server computer that is connected to a network and at least one client computer that performs data transmission with said server computer via said network; and sends basic data for CAD graphic data from said server computer to said client computer according to a request from said client computer; wherein said server computer comprises: a storage means that stores basic data for said graphic data; and a program data transmitting section that reads said basic data for graphic data from said storage means according to a request from said client computer, and sends that data to said client computer; said client computer comprises: a program data receiving section that receives said basic data for graphic data; a computing section that creates graphic data based on said basic data for graphic data; and a CAD graphic data producing section that creates display data for the graphic display unit in said client computer based on the graphic data created by said computing section; said basic data for graphic data comprises a plurality of variable programs for drawing different graphics and real-number data that is substituted into the variables of said variable programs; said storage means of said server computer comprises a variable program storage section that stores said plurality of variable programs, and a real-number data storage section that stores a plurality of kinds of said real-number data; said program data transmitting section reads a specified variable program from said variable program storage section, and reads specified real-number data from said real-number data storage section according to a request from said client computer, then sends that data to said client computer; said variable program is created using an interpreter-type programming language; and said computing section of said client computer comprises an interpreting function for interpreting said interpreter-type programming language, and substitutes said specified real-number data into the variables of said specified variable program, then executes that variable program while interpreting it by the interpreting function for interpreting interpreter-type programming language, and creates graphic data.

3. The CAD system utilizing a network according to claims 1 or 2 wherein said client computer comprises a graphic name list display control section for displaying a list of received graphic names of the basic data for graphic data provided from said server computer on the display unit; and a selected graphic name transmitting section that sends the names of graphics selected from said list of graphic names to said server computer; said program data transmitting section in said server computer reads said specified variable program and specified real-number data based on the graphic names that were sent from said selected graphic name transmitting section.

4. The CAD system utilizing a network according to claims 1 or 2 wherein said server computer comprises a parts data list storage section that groups and stores part code numbers for each part and said real-number data corresponding to the code numbers; said program data transmitting section transmits the part data list containing the code numbers and the real-number data to said client computer according to a request of said client computer; said client computer comprises: a code number list display control section that creates a parts code number list from said sent parts data list transmitted, and displays the list on said graphics display unit; and said computing section substitutes real-number data for the parts that correspond to the names of the part code numbers selected from said displayed parts code number list into the variables of the variable program that corresponds to the names of said graphics and creates graphic data.

5. The CAD system utilizing according to claim 4 wherein when part or all of the real-number data corresponding to the part code numbers selected from said part code number list in said client computer is input data that was input by the user, said computing section of said client computer substitutes said real-number data that was read from said parts data list storage section and said input data into the variables in said corresponding variable program and creates graphic data.

6. The CAD system utilizing a network according to claims 1 or 2 wherein said client computer comprises a data format name selection function that is capable of selecting a data format name for the CAD software; and said CAD graphic data producing section converts the format of the graphic data created by said computing section, creates CAD graphic data having said selected data format, assigns a file name and stores the data in the memory unit.

7. The CAD system utilizing a network according to claims 1 or 2 wherein said client computer comprises an interface name selection function that is capable of selecting a name for the data-exchange interface provided by the CAD software; and said CAD graphic data producing section converts the format of the graphic data created by said computing section to create CAD graphic data, and registers said CAD graphic data directly in said CAD software by way of said data-exchange interface.

8. The CAD system utilizing network according to claims 1 or 2 comprising a parts database management program for managing parts data in said program data transmitting section of said server computer.
